(19) United States
(12) Patent Application Publication
(10) Pub. No.: US 2011/0003144 A1
(43) Pub. Date: Jan. 6, 2011

(54) Capillary-channeled polymer fibers modified for defense against chemical and biological contaminants

(76) Inventors: Philip John Brown, Williamston, SC (US); R. Kenneth Marcus, Seneca, SC (US); Christine W. Cole, Six Mile, SC (US); Igor A. Luzinov, Central, SC (US)

Correspondence Address: K&L Gates LLP, 214 N. TRYON STREET, HEARST TOWER, 47TH FLOOR, CHARLOTTE, NC, 28202, US

(21) Appl. No.: 11/983,824

(22) Filed: Nov. 13, 2007

Related U.S. Application Data
(60) Provisional application No. 60/858,878, filed on Nov. 14, 2006.

(51) Int. Cl. D02G 3/00; B05D 3/10

(52) U.S. Cl. 428/332; 428/400; 427/2.31

(57) ABSTRACT

A method of preparing a fiber or an article suitable for use in defending against a biological or a chemical contaminant, and the fiber or article resulting from the method thereof, is disclosed. The method includes obtaining a fiber such as a capillary-channeled fiber with a surface having grooves or channels thereon and modifying the surface of the fiber with an active agent so as to provide the fiber with the ability to defend against a biological or a chemical contaminant.

### CROSS-REFERENCE TO RELATED APPLICATION

The present application claims priority from U.S. Provisional Application No. 60/858,878, filed on Nov. 14, 2006, the entirety of which is incorporated herein by reference.

### FIELD OF THE INVENTION

The present invention relates to fibers for defense against a range of chemical and biological contaminants such as for purposes of rejection and repulsion of and decontamination and detoxification from such contaminants. Particularly, the present invention relates to capillary-channeled polymer fibers for use in defending against such contaminants.

### BACKGROUND OF THE INVENTION

There is an elevated global need to protect individuals against harmful biological and chemical contaminants in the environment. However, this need has been especially great with respect to providing protection against biological and chemical contaminants from the perspective of national defense. Citizens, military personnel, medical personnel, and other emergency personnel may be exposed to harmful or even life-threatening biological or chemical contaminants.

There are also economic realities that dictate that there be cost-effective means of providing such protection. Thus, it would be particularly desirable to provide an article or a component for use in an article and a method of making such article or component that is both cost-effective and resistant to as many biological and chemical contaminants as possible such that the article is adaptable for use across a broad range of end use applications.

It is also desirable to provide an article or a component that has other beneficial properties such as flame-resistance, UV protection, and durability, to name a few. Furthermore, it is desirable to provide an article that is flexible such that it can be formed into a wearable material with the capability to protect against presently known contaminants as well as presently unknown contaminants that may be created or identified in the future.

Therefore, the present invention attempts to fulfill these needs and solve the above problems.

### SUMMARY OF THE INVENTION

The present invention relates to a method of preparing a fiber or an article suitable for use in defending against a biological or a chemical contaminant, and the fiber or article resulting from the method thereof. The method includes extruding a fiber to have a non-circular cross section and a fiber shape as well as other parameters such that the fiber defends against a biological or a chemical contaminant. The method also includes providing a fiber with a non-circular cross section, preferably a fiber having grooves or channels on the surface, and modifying the surface of the fiber with an active agent so as to provide the fiber with the ability to defend against a biological or a chemical contaminant.

In particular, a fiber may be used, either alone or in combination, in order to defend against biological or chemical contaminants and to work effectively in applications where defense against chemical and biological contaminants is required. As such, the present invention should be particularly advantageous for use in military, first responder, and medical personnel apparel.

The fiber may be present in some proportion in a resulting article. The article may be in many forms, for example, a fabric or a non-woven. The fibers may be of many different compositions, forms, sizes and non-circular cross sectional shapes. The fibers may also be formed of or treated with specific chemistries that are suitable for use in defense of biological and chemical contaminants.

There are various aspects to the method of preparing a fiber or article suitable for use in defending against biological and chemical contaminants. Namely, these aspects comprise: (1) applying, such as by chemical bonding, an active agent to a fiber by a coating, such as a homogeneous solution or by application of a film to the fiber, to utilize the high surface area and channel structure of the fiber and to load the fiber with chemicals that defend against a particular chemical or biological contaminant; (2) applying an active agent to a fiber by use of non-homogeneous particulate matter such that there is an immobilization of particulate species yielding a non-homogeneous surface within the channel structures of the fiber having an active chemical component; and (3) selecting specific channel geometries and sizes of the fibers to effectively filter, exclude, repel or defend against particulates, biological aerosols and other cellular matter from passing through or perhaps adhering to fiber or the resulting article.

It is particularly advantageous that each of the various aspects of the present invention described above may be employed alone or in combination as is desirable in a particular end use application. As such, creation of a fiber or an article such as a fabric material or non-woven would provide a base level of protection. Modified polymer fibers may further be treated with additional additives, such as by application of an additional coating to the fibers after immobilization of particulate species, such that the fibers have additional properties that may be desirable for a range of end-use applications. Such properties may include, but are not limited to, flame-resistance, UV protection, and durability. Articles composed of fibers modified in accordance with the present invention may be utilized across a broad range of end products or end uses such as, for example, protective outerwear and gear, clothing, face masks, tent netting and filters such as air filters.

### BRIEF DESCRIPTION OF THE DRAWINGS

For a more complete understanding of this invention reference should now be had to the preferred embodiments illustrated in greater detail in the accompanying drawings and described below. In the drawings, which are not necessarily to scale:

FIG. 1A is a schematic representation of the steps for chemically bonding an active agent to a fiber by a homogeneous coating;

FIG. 1B is a schematic representation of the steps for applying an active agent to a fiber by use of non-homogeneous particulate matter;

FIG. 1C is a schematic representation of selecting specific channel geometries and sizes of the fibers to filter, exclude, repel or defend against targeted matter;

FIG. 2A is a representation of a cross section of a circular polymer fiber having a coating applied to the surface thereof, for comparative purposes;

FIG. 2B is a representation of a cross section of a capillary-channeled polymer fiber having a coating applied to the surface thereof, for use in accordance with the present invention;

FIG. 2C is a representation of the capillary-channeled polymer fiber of FIG. 1B with channels loaded in total;

FIG. 3A is an atomic force microscopy topography image depicting surface modification to poly(ethylene terephthalate) (PET) with a hydrophobic polymer;

FIG. 3B is an atomic force microscopy topography image depicting surface modification to poly(ethylene terephthalate) (PET) with a hydrophilic polymer;

FIG. 4 is a scanning electron microscopy image of a capillary-channeled polymer fiber having channels filled with particulate matter through dip coating;

FIG. 5A is a scanning electron microscopy image side view of a capillary-channeled polymer fiber with 10 percent by weight calcium carbonate nano-particles applied to the surface thereof through dip coating;

FIG. 5B is a scanning electron microscopy image side view of a capillary-channeled polymer fiber with 2.5 percent by weight calcium carbonate nano-particles applied to the surface thereof through dip coating;

FIG. 6 is a representation of the cross section of a capillary-channeled polymer fiber with filled channels, depicting fiber surface protection from abrasion;

FIG. 7 is a scanning electron microscopy image of a capillary-channeled polymer fiber with channels sized to reject cells and spores of sizes larger than the channels;

FIG. 8 is a representation of the cross section of a capillary-channeled polymer fiber rejecting a cell through a shark-skin effect;

FIG. 9 is a diagram depicting the process of electrospraying particles containing polymer solutions to coat a capillary-channeled polymer fiber;

FIG. 10 is a scanning electron microscopy image of a capillary-channeled polymer fiber having channels filled with particulate matter through spray deposition;

FIG. 11 is a diagram depicting the injection method of dip coating to coat a capillary-channeled polymer fiber;

FIG. 12A is a scanning electron microscopy image of a capillary-channeled polymer fiber after treatment by dip coating injection with 16 percent particles by weight and 3.5 percent polyvinyl alcohol (PVA) solution by weight;

FIG. 12B is a scanning electron microscopy image of a capillary-channeled polymer fiber after treatment by dip coating injection with 25 percent particles by weight and 4 percent polyvinyl alcohol (PVA) solution by weight;

FIG. 12C is a representation of the cross section of a capillary-channeled polymer fiber after treatment by dip coating injection; and

FIG. 12D is a scanning electron microscopy image of a polyester grooved fiber material woven from capillary-channeled polymer fibers, whereby the material has been treated with particle containing solutions by a dip coating method.

### DETAILED DESCRIPTION OF THE INVENTION

The present invention will now be described fully hereinafter with reference to the accompanying drawings, in which preferred embodiments of the invention are shown. This invention may, however, be embodied in many different forms and should not be construed as limited to the preferred embodiments set forth herein. Rather, these preferred embodiments are provided so that this disclosure will be thorough and complete, and will fully convey the scope of the invention to those skilled in the art. It will be understood that all alternatives, modifications, and equivalents are intended to be included within the spirit and scope of the invention as defined by the appended claims.

The term “fiber,” as used herein, refers to an elongated natural, man-made, or synthetic textile material of definite length or indefinite length, where “elongated” means greater in length than in width. A filament is an example of a fiber of indefinite length.

For purposes of this disclosure, the terms fiber “shape” and fiber “geometry” are equivalent terms. Furthermore, the term fiber “denier” is commonly used to describe or refer to the density of a fiber, which is related to the diameter per unit length for a circular cross section fiber of a given polymer. As this quantity may not necessarily be applicable in the case of capillary-channeled fibers and other non-circular cross section fibers, the term fiber “diameter” is used for purposes of this disclosure to describe or refer to the cross sectional size of a fiber.

Fibers of non-circular cross section are preferred for use in connection with the present invention. One type of non-circular cross section fiber for use in connection with the present invention is a capillary-channeled polymer fiber. The capillary-channeled polymer fibers suitable for use in the present invention include, but are not limited to, those fibers described in U.S. Pat. Nos. 5,200,248 and 5,972,505, the entirety of each of which is incorporated herein by reference. Other types of non-circular cross section fibers suitable for use in connection with the present invention include, but are not limited to COOLMAX® and ANTRON® fibers, which are manufactured by Invista of Waynesboro, Va., and HIGHLIGHTS™ fibers, which are manufactured by Superior Threads of St. George, Utah.

The fibers may be comprised of any polymeric material. Preferred polymeric materials include, but are not limited to, polyester, polyamide, copolymers, thermoplastics, thermosets, and combinations thereof. One may also incorporate into the base polymer fiber an active agent that is capable of leaching from the base polymer over a period of time for a controlled release effect.

Either of the terms “defend” or “defense,” as used herein, generally refer to rejection, repulsion, decontamination, detoxification, or any other manner in which to protect against a chemical or biological contaminant.

The present invention relates to a method of preparing a fiber or an article suitable for use in defending against a biological or a chemical contaminant, and the fiber or article resulting from the method thereof. In particular, a capillary-channeled polymer fiber may be used, either alone or in combination, in order to achieve this objective and to work effectively in applications where defense against chemical and biological contaminants is required. As such, the present invention should be particularly advantageous for use in military, first responder, and medical personnel apparel.

The fiber of the present invention may be present in some proportion in a resulting article. The article may be, for example, in the form of a fabric or a non-woven. The fibers may be of many different compositions, forms, sizes and non-circular cross sectional shapes. The fibers may also be formed of or treated with specific chemistries that are suitable for use in defense of biological and chemical contaminants.

There are various aspects to the method of preparing a fiber or article suitable for use in defending against biological and chemical contaminants. Namely, these aspects comprise: (1) applying, such as by chemical bonding, an active agent to a fiber by a coating, such as a homogeneous solution or by application of a film to the fiber, to utilize the high surface area and channel structure of the fiber and to load the fiber with chemicals that defend against a particular chemical or biological contaminant; (2) applying an active agent to a fiber by use of non-homogeneous particulate matter such that there is an immobilization of particulate species yielding a non-homogeneous surface within the channel structures of the fiber having an active chemical component; and (3) selecting specific channel geometries and sizes of the fibers to effectively filter, exclude, repel or defend against particulates, biological aerosols and other cellular matter from passing through or perhaps adhering to fiber or the resulting article.

It is particularly advantageous that each of the various aspects of the present invention described above may be employed alone or in combination as is desirable in a particular end use application. As such, creation of a fiber or an article such as a fabric material or non-woven would provide a base level of protection. Fibers may further be modified with additional additives on the fiber surface, such as by application of an additional coating to the fibers via a homogenous solution method or after immobilization of particulate species within the fiber channels, such that the fibers have additional properties that may be desirable for a range of end-use applications. By the same processes, other highly desirable properties may be bestowed on the fibers and fabrics thereof. Such properties may include, but are not limited to, flame-resistance, UV protection, and durability. One of ordinary skill in the art would appreciate that articles composed of fibers modified in accordance with the present invention may be utilized across a broad range of end products or end uses such as, for example, protective outerwear and gear, clothing, face masks, tent netting and filters such as air filters. Each of these various aspects of the present invention are described in detail herein and, in particular, with reference to the specific examples set forth below.

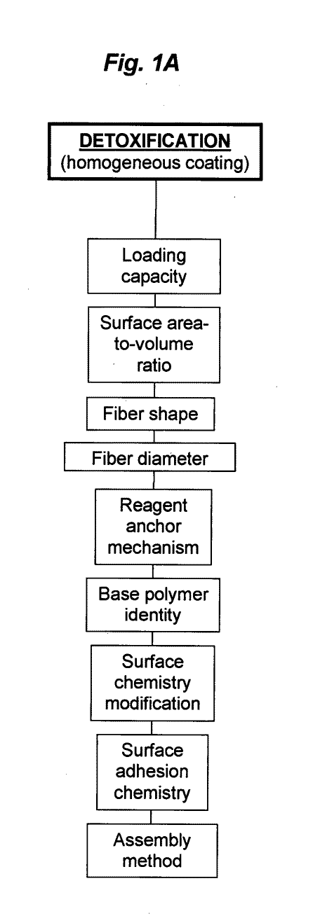

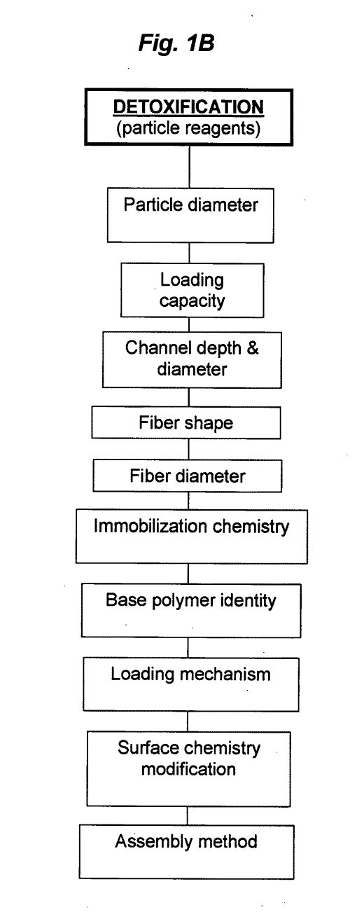

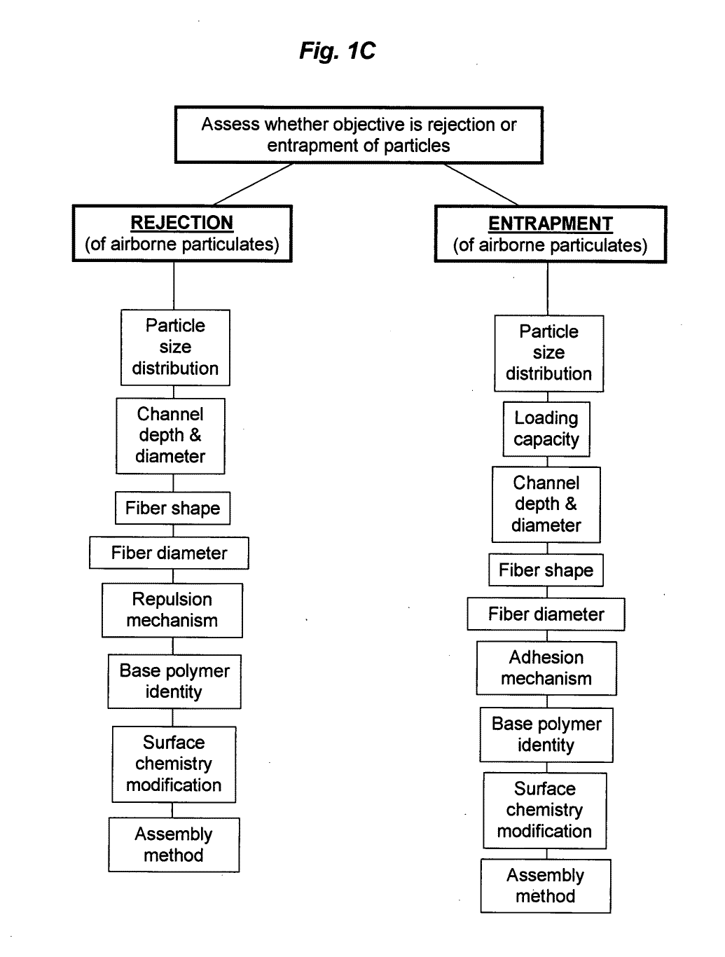

With respect to the first aspect of the present invention, namely modifying the surface and channels of a fiber in order to chemically bond an active agent to the fiber by a homogeneous liquid treatment, reference is made to FIG. 1A, which sets forth the methodology for preparing a fiber in accordance with this aspect. Once a suspected chemical or biological toxicant has been identified, a detoxifying agent to respond to that chemical or biological toxicant may be selected. As shown in FIG. 1A, in preparing the fiber platform, the fabric loading density or loading capacity is projected based upon the required concentration of the agent. A factor in this determination is the surface area-to-volume ratio that is necessary to meet the loading density or loading capacity requirement. The surface area-to-volume ratio is primarily dictated by two fiber parameters—the fiber shape and the fiber diameter. Fiber shape and fiber diameter also have an important bearing on the mechanical properties of the final product in terms of weight, density, breathability, and feel. As a result, it is important that all of these parameters be considered in setting the physical qualities of the fiber platform.

Once the fiber platform is determined, any chemical attributes or characteristics are determined. Viable detoxifying agents are likely to have some chemical functionality, such as amine, carboxylate, or thio groups, that will allow their coupling or anchoring to a surface. The selection of the base polymer identity is made relative to the most likely anchoring mechanism. For example, if the chemical agent is best coupled to a surface through a protonated amine functionality, then a polymer surface having negative charge groups would be desirable. Other considerations on the base polymer identity would include wettability, desire for wicking, compatibility with other structure constructs and methods, and wearability. In the present example, polyester may be the best choice for the base polymer identity. It may be found, though, that the native negative ion density on the polyester may be insufficient to achieve the desired loading capacity. As such, a surface chemistry modification may be in order to increase the number of carboxylate groups on the surface. Surface modifications to achieve this end include various surface modification chemistries including, but not limited to, alkaline treatments, plasma treatments, and further chemical couplings. Optimization of each of these chemical interactions or processes is required to achieve a fiber of the desired target performance criteria and the eventual assembly of the final product that incorporates the fiber therein. The fiber may be in any number of forms including, but not limited to, filament, yarn, and staple. Assembly occurs via a variety of known woven and non-woven procedures. The relative percentage of the treated fibers, as opposed to other fiber types, may be varied to optimize performance. In addition, the sequence of processes may involve creating the physical constructs or articles and then performing the chemical modification and coupling steps.

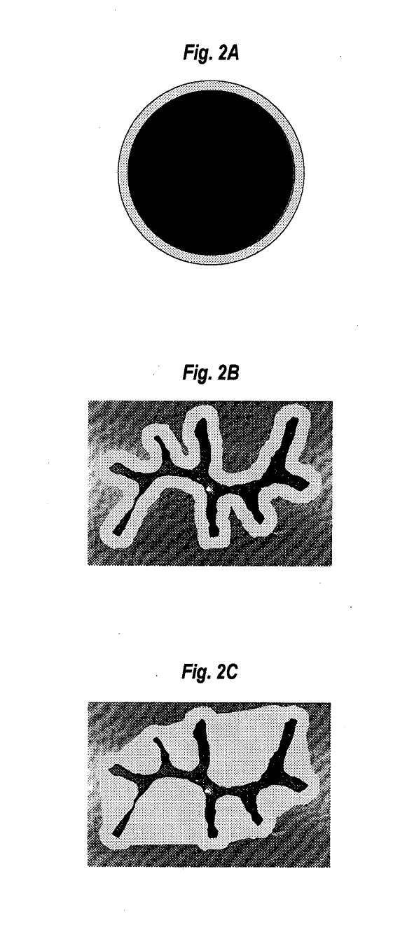

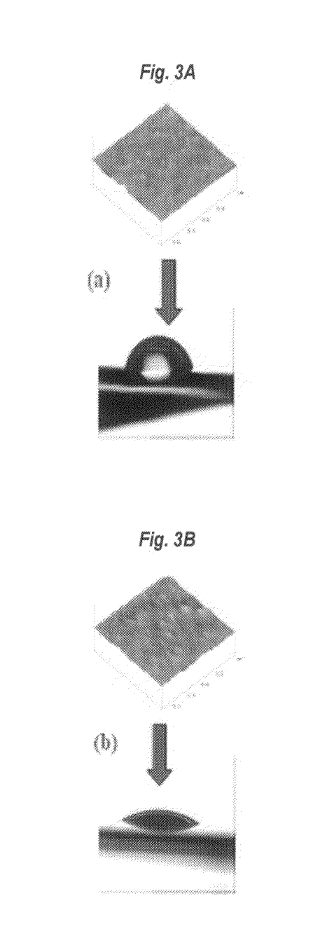

FIG. 2A is a representation of a cross section of a circular cross section fiber with a coating of some thickness comprising the active agent applied to the surface thereof. In contrast, FIGS. 2B and 2C are representations of cross sections of a capillary-channeled polymer fiber suitable for use in accordance with the present invention. FIG. 2B depicts a capillary-channeled fiber with a coating applied to the surface thereof of the same thickness as the coating of FIG. 2A. FIG. 2C depicts the capillary-channeled fiber with a coating applied to the surface thereof, whereby the channels of the fiber are loaded in total with the active agent. As can be seen in FIGS. 2B and 2C, the capillary-channeled polymer fiber has a surface area approximately three times the surface area of the circular cross section fiber shown in FIG. 2A. As such, the coating applied to the capillary-channeled polymer fiber may be approximately three times as extensive as that of the circular cross section fiber. Furthermore, the capillary-channeled polymer fibers are advantageous because, due to the grooves and channels in the fiber, the fiber provides the ability for greater loading of layers of various chemical species that can act to deactivate chemical contaminants. The effectiveness of such surface chemistries is greatly enhanced by the increase in mass loading, as shown in FIGS. 2A and 2B. Furthermore, the filling of the void spaces within the channels provides even greater loadability on a volume basis as shown in FIG. 2C. Greater loadability by volume may be used advantageously to enhance particle immobilization as discussed in greater detail below.

There are various advantages and disadvantages associated across the range of fiber cross sectional shapes and diameters depending upon the end use and the type of contaminant. For example, in some instances, small diameter fibers (e.g. 10 microns) provide greater amounts of surface area per unit cross sectional area, while large diameter fibers (e.g., 50 microns) provide greater amounts of channel volume. Fibers with lower diameter may be preferable in situations where decontaminants are applied as thin films and surface area is the controlling factor in efficiency. Alternatively, fibers with larger diameters are preferred when applications require greater volumes and greater masses of coatings. A wide variety of detoxification chemistries may be employed that are specific to particular agents, chemicals or media. Furthermore, if certain parameters of the fiber are selected to defend against an identified chemical or biological contaminant, then surface modification may not be necessary.

For instance, the use of ultra-hydrophobic coating technologies is an example of instilling the ability to repulse water. For example, application of a nanocoating process may be employed, whereby materials may be grafted to the capillary-channeled polymer fiber surface. The channels of the fibers may be modified and filled with different materials. Polymers possessing different functional groups such as carboxy, anhydride, amino and hydroxy groups may be grafted to the fiber surface employing the nanocoating process. These groups may later be utilized to attach various functional molecules, biomolecules, micro-particles and nano-particles. For example, capillary-channeled polymer fibers made of poly(ethylene terephthalate) (PET) may successfully be modified with a polyacrylic acid layer by this method of grafting. Surface modification of substrates in accordance with this grafting process is taught by U.S. Pat. No. 7,026,014, the entirety of which is incorporated herein by reference. Additionally, direct surface modifications can be used to establish a surface to which active ingredients can be anchored. For example, treatment of a nylon fiber surface with ethylene-diamine creates a surface that is rich with both carboxylate and amine functionalities. Functionalization of the surfaces either through grafting or direct surface modification allows for decontaminant immobilization through a number of chemistries. Such chemistries may include formation of an amide linkage by reacting an aminated reagent molecule with a surface composed of carboxylate groups or the reverse situation, whereby an amide linkage is established by reacting a reagent molecule having carboxylate groups with an aminated surface.

Additionally, hydrophobic and hydrophilic homopolymers, statistical and block copolymers may be firmly attached to the capillary-channeled polymer fibers. For instance, hydrophilic poly(ethylene glycol) (PEG) and hydrophobic polystyrene (PS) polymers may be attached to various polymeric substrates such as poly(ethylene terephthalate) (PET), nylon, poly(vinylidene fluoride) (PVDF), polyethylene and polysiloxane surfaces. FIGS. 3A and 3B show morphology and wettability of PET surface modified with PS and PEG grafted layers. The atomic force microscopy images revealed that the polymeric surface was completely covered with the grafted layers and the polymer grafted layers dictated the surface properties of the polymer film. The thickness of the grafted layers ranges from 1.5 nm to 1000 nm. As shown in the lower portions of FIGS. 3A and 3B, differences in wettability of the two surface treatments is based on the contact angle of water droplets placed on the fiber surfaces. In FIG. 3A, the water droplet is repelled by the hydrophobic PS treatment. In FIG. 3B, the droplet is seen to better wet the surface due to the PEG surface treatment.

The fiber surface modifications that may be employed to affect chemical detoxification or biocidal activity are quite diverse, ranging from simple chemical functional groups to macromolecular approaches. For example, simple quarternary ammonium groups are well known to have biocidal activity. Examples of “macro”-functional species that may be coupled to fiber surfaces to affect chemical warfare agent detoxification include, but are not limited to, catalysts synthesized from β-cyclodextrin and o-iodosobenzoic acid for organophosphosphate (OP) deactivation. OP nerve agents include sarin and VX. A number of enzyme species can be immobilized as well to de-activate the OP agents, including diisopropylfluorophosphatases (DFPases) and organophosphohydrolase (OPH). Furthermore, the fiber surface and groove structure may be used to immobilize bacteria (such as E. coli) that in themselves can be engineered to release the desired decontaminant enzymes. There are also proteins, known as lysins, that can be immobilized on the fiber surfaces. Lysins destroy the cell walls of bacteria (such as Bacillus anthracis), thus killing the bacteria.

With respect to the aspect of the present invention pertaining to applying an active agent to a fiber by use of non-homogeneous particulate matter such that there is immobilization of particulate species within the channel structures as active chemical components, reference is made to FIG. 1B. Once the suspected chemical or biological toxicant has been identified, then a detoxifying agent may be selected. A number of detoxifying agents exist as particulates or are best applied in particulate form. For example, a class of silver nanoparticles is known to have anti-microbial activity. Other metals and inorganic or organic particulates may have a variety of advantageous properties. The particle diameter of the detoxifying agent is identified. Based upon the required concentration of the detoxifying agent, the fabric loading density or loading capacity may be projected.

A fiber characteristic of relevance here is a match between the particle size and the achievable volume/mass loading capacity of the fiber channels. For example, the highest level of loading can be attained if the channel diameter is much larger than the size of the particle agents. This is dictated by two fiber parameters—the fiber shape and the fiber diameter. The fiber shape and fiber diameter also have an important bearing on the mechanical properties of the final product in terms of weight, density, breathability, and feel. All of these parameters factor into the determination of the physical qualities of the fiber platform.

Selection of the base polymer identity is made relative to the most likely particle anchoring and deposition mechanism. Agent particles may be affixed to the fiber/channel surface by either physical or chemical means.

Considerations described in connection with the first aspect, discussed above, are relevant here if chemical processes are exercised. An example of a physical anchoring may be thermal treatment that would cause the partial collapse of the channel walls around the particles. In that instance, the melting point of the base polymer would be relevant. The deposition or loading mechanism of the particulate agents also have a bearing on the choice of the base polymer identity. For example, electrospray or dip-coating processes are common deposition or loading mechanisms. In the case of dip-coating, the wetting/wicking characteristics of the polymer could be chosen to facilitate the process. The base polymer itself may not possess the optimal set of surface chemical characteristics with regards to loading or immobilization, and so post-extrusion modification may be in order. Surface chemistry modifications to achieve this end might include, for example, alkaline/acid treatments, plasma treatments, or further chemical couplings.

Other considerations on the base polymer identity include, but are not limited to, general wettability, desire for wicking, compatibility with other structure constructs and methods, and wearability. Optimization of each of these particle interactions and processes is needed to achieve a fiber meeting the desired target performance criteria and the eventual assembly of the final product that incorporates the fiber therein. The fiber is in any number of forms including, but not limited to, filament, yarn, and staple. Assembly occurs via a variety of known woven and non-woven procedures. The relative percentage of the treated fibers, as compared to other fiber types, may be varied to optimize performance. In addition, the sequence of processes may involve creating the physical constructs or articles and then performing the chemical modification and particle loading steps.

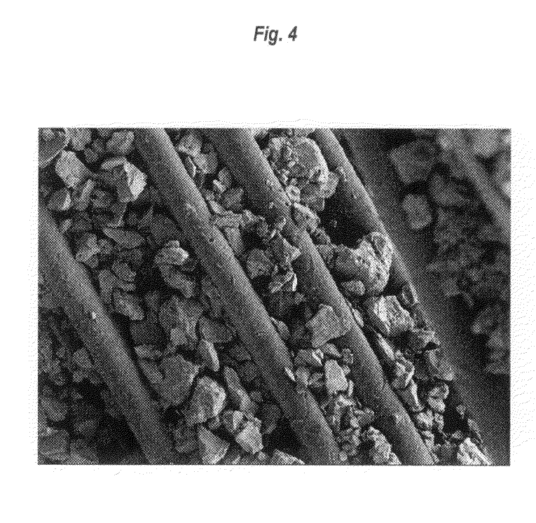

Turning now to FIGS. 4, 5A-5B and 6, it is shown that the physical structure of the capillary-channeled polymer fibers is advantageous for use in applications in which particles in the range of nanometer to micrometer size are used to affect decontamination and detoxification. With reference to FIG. 4, capillary-channeled polymer fibers provide a means of encapsulating particles within the channel structures. The width and depth of the channels may be tailored to accommodate particles of varying size as well as accommodate varying mass loadings. For example, increases in fiber winding speed/tension can effect the creation of lower diameter fibers having smaller diameter channels. As can be appreciated, fibers having channels of smaller diameters than the immobilized particulate agents would prohibit their inclusion within the channels.

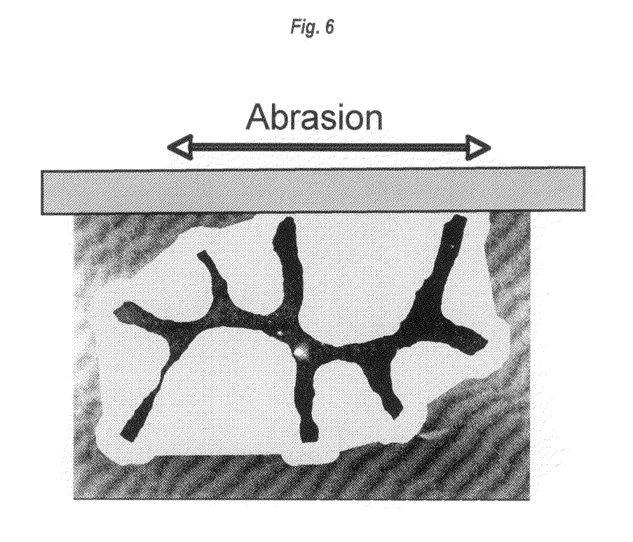

With reference to Examples 2-4, discussed below, filling of capillary-channeled polymer fiber channels with particulate matter (loading mechanism) may be accomplished by any method known to one of ordinary skill in the art including, but not limited to, dip coating, flowing slurries, spray deposition and use of wicking action. With reference to FIG. 6, placement of particles within the channels provides protection from abrasion from the fiber surface as physical contact would occur at the tops of the channel walls and not against the surface to which the particles are affixed, as might also be realized for the general case of surface films and filling of channels with homogeneous materials. Examples of active particulates for immobilization include, but are not limited to, metal oxides such as titanium dioxide (TiO₂) and metal micro and nano-particles of silver (Ag) and copper (Cu), each of which are understood to have anti-bacterial and anti-microbial activity.

With respect to the aspect of the present invention pertaining to use of the selection of the fiber geometry or shape to affect particulate, biological aerosol and spore filtration or rejection, reference is made to FIG. 1C. An initial determination is made regarding whether the objective is rejection or entrapment of particulate matter. If the objective is rejection of airborne particulates, the rejection criteria on the left hand side of FIG. 1C is followed. If the objective is entrapment of airborne particulates, then the right hand side of FIG. 1C is followed. The rejection of airborne particulates that are biological in nature, such as spores, bacteria, and viruses, occurs via what is termed the “shark skin effect.” In this process, bioadhesion is mitigated by the proper choice of surface topography, surface energy and chemistry, and mechanics. Once the suspected biological threat species has been identified, then the fiber physical platform and chemical characteristics are selected to repel that organism.

Since the identity of the particles to which there will be exposure is unknown, a particle size distribution is considered as opposed to a specific particle diameter. In the rejection of particles, the choice of the channel depth and diameter serve at least two key roles. The separation between the channel walls must be smaller than the threat species to prohibit insertion, and the depth must be sufficient to provide physical “flex” against the impacting particle. Different from the loading of particulates of known identity, the choice of diameter reflects the potential range of sizes of biological agents. These parameters are manifested in the selection of the fiber shape and fiber diameter. Additionally, the fiber shape and fiber diameter have an important bearing on the mechanical properties of the final product in terms of weight, density, breathability, and feel. All of these parameters may be considered in setting the physical qualities of the fiber platform. In some instances, it may not be necessary to implement any further modifications to the fiber platform, chemical or otherwise, provided however that the physical parameters of the fiber platform satisfy the objectives to effectuate particulate, biological aerosol and spore filtration or rejection.

The chemical make-up of the surface of the biological particle dictates the counter properties of the fiber surface that act to prevent bioadhesion. As such, the repulsion mechanism determines the base polymer chemistry or potential surface modifications to be made. In general, low surface energy materials, such as hydrophobic materials, are most effective in minimizing the adhesion of particulate matter such as spores. As such, polypropylene is a preferred selection in this application. Alternatively, if fabric characteristics dictate, a polyester base fiber modified to exhibit extreme hydrophobicity might be preferred. Optimization of each of these particle interactions and processes achieves fibers of the desired target performance criteria and the eventual assembly of the final product that incorporates them.

The fiber may be in any number of forms including, but not limited to, filament, yarn, and staple. Assembly occurs via a variety of known woven and non-woven processes. The relative percentage of the treated fibers, as compared to other fiber types, may be varied to optimize performance. In addition, it may be true that the sequence of processes may involve creating the physical constructs and then performing any chemical modification step.

FIG. 1C also illustrates the selection criteria for fibers suitable for the collection or entrapment of particulate matter. Collection and filtration of airborne, non-biological particulates that pose health risks is the most common type of hazard protection. In this process, physical entrapment of the airborne particles within the fabric structure is the goal. The fabric structure may take the form of any of a broad range of end products, including, but not limited to protective outerwear and gear, clothing, face masks, tent netting and filters. Threat agents may take many different forms, such as an oxide dust contaminated with radioactive material. Once the suspected threat agent or agents have been identified, other criteria such as the particle size distribution and loading capacity are considered. With this criteria, the physical fiber characteristics are selected to entrap the particles both within the channels of the fibers and in the construct of the fabric as a whole.

As with rejection, particle size distribution is considered. Channel depth and diameter of the fiber are considered. Channel shape is selected to allow highest exposure for facile channel entry. The channel diameter is selected to be sufficiently large so as to allow particles access, but to still be immobilized without “falling out.” Different from the loading of particulates of known identity, the selection of fiber diameter reflects the potential range of sizes of the anticipated particles. Fiber diameter plays an important role in the overall efficiency of a filtering process, as low fiber diameters allow for high fiber densities and interception efficiencies in the final constructs or articles. Additionally, the fiber shape and fiber diameter dictate the loadability of the fibers (i.e., their useful lifetime). The fiber shape and fiber diameter also have an important bearing on the mechanical properties of the final product in terms of weight, density, breathability, and feel. This is a non-exclusive list of parameters to consider in determining the physical qualities of the fiber platform. Again, as with rejection, it may not be necessary in some instances to implement any further modifications to the fiber platform, chemical or otherwise, provided however that the physical parameters of the fiber platform satisfy the objectives to effectuate collection or entrapment of the targeted particulate matter.

Another consideration in the method of the present invention is the identification of a base polymer. To a first approximation, physical collection and filtration can be achieved using base polymers chosen simply by cost and processing considerations. In specific cases, the chemical make-up of the surface of a non-biological particle can play a role in the filtration process. For example, oxide particles generally possess a native charge that can be exploited to further aid in immobilization. As such, polypropylene might be a likely first choice for simple physical entrapment, but a base fiber or modification of a surface may enhance adhesion. One example is plasma treatment of a nylon fiber to increase the surface charge density. Optimization of each of these physical and chemical characteristics achieves fibers of the desired target performance criteria and the eventual method of assembly for the final product that incorporates them. The fiber may be in any number of forms including, but not limited to, filament, yarn, and staple. Assembly occurs via a variety of known woven and non-woven procedures. The relative percentage of the treated fibers, as compared with other fiber types, are varied to optimize performance. In addition, it may be true that the sequence of processes may involve creating the physical constructs or articles and then performing any chemical modification.

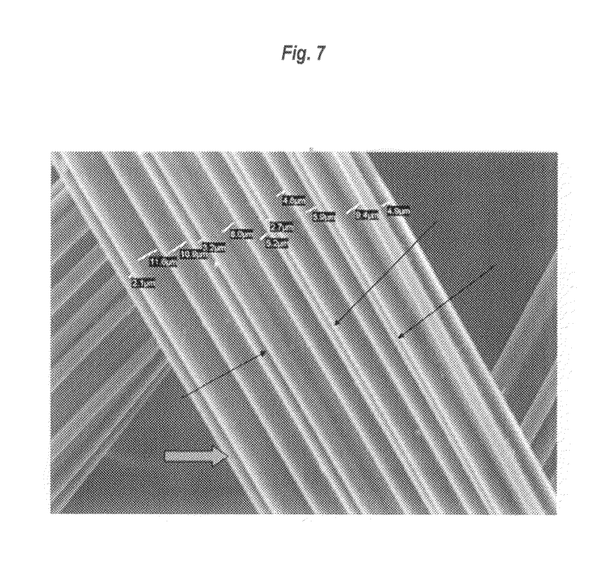

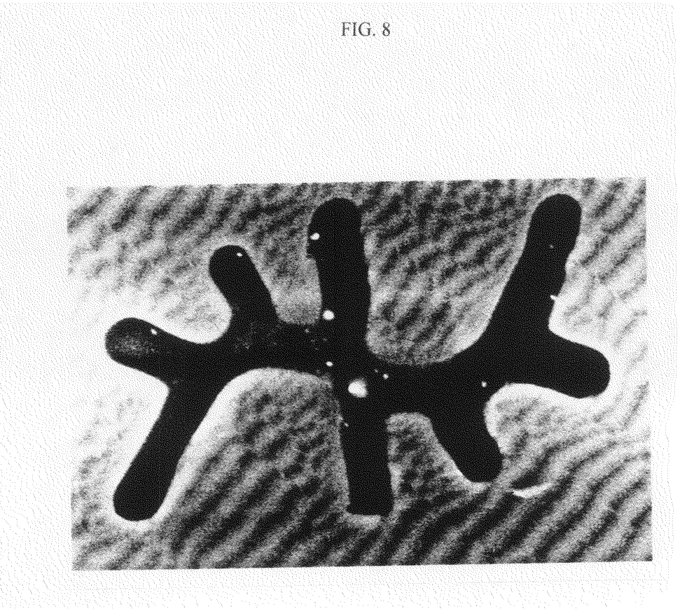

With specific reference to FIGS. 7 and 8, capillary-channeled polymer fibers may be modified to either entrap contaminants within a fabric matrix or to reject such material from sticking or adhering to the surface of the structure. Physical entrapment not only keeps particulates from being inhaled or making contact with skin, but also acts as a means to allow the above mentioned decontamination chemistries to occur. Rejection of spores and particularly cells is accomplished based on the fact that the grooves of the drawn filaments can be reduced to the order of single micrometers, as shown in FIG. 7. As such, impact by larger bodies results in their rejection. This is known as the “shark-skin” effect and is depicted schematically in FIG. 8. Thus, filtration and rejection are essentially opposite processes, either of which can be affected as determined for a specific application.

Bioadhesion involves a complex set of interactions between living organisms, cells, and spores with a surface that results in attachment. Surface chemistry and topology play key roles in how a particular cell, spore or particle will interact with a surface. In terms of chemistry, the surface energy, such as hydrophobicity, of the capillary-channeled polymer fibers may be modified using the grafting technologies described previously with reference to loading fibers for defense against biological or chemical contaminants. Fiber channel diameters may be selected in accordance with the present invention specifically to block threat agents based on their physical dimensions. For example, typical gram-negative bacteria are on the order of 3 μm in their largest dimensions, though there are shape aspects to their adhesion/blockage as well. For example, Bacillus anthracis spores may be up to 5 μm in length, with widths of about 1 μm. Vegetation spores occur at sizes above about 5 μm. As such, both the width and shapes of the particular capillary-channeled polymer fiber are also parameters which may be optimized for a specific projected threat agent.

### EXAMPLES

### Example 1

Example 1 pertains to the aspect of the invention directed to modification of fiber surfaces and channels for chemical species decontamination and repulsion, and specifically to a method of surface grafting. The method of surface grafting was applied to the surface of poly(ethylene terephthalate) (PET) fibers. The fibers were first cleaned in acetone to remove finishes and/or contaminations deposited on the fibers during fabrication. Next, the fibers were treated using a plasma or corona discharge, or a concentrated solution of 1 M sodium hydroxide (NaOH) in water. The treatment is necessary to create functional groups on the fiber surface. After the treatment, the materials were washed with water and/or ethanol. Poly(glycidyl methacrylate) (PGMA) was deposited on the fibers by dip coating or adsorption from 0.1 to 5 weight/volume percent methyl-ethyl ketone (MEK) solution. After the PGMA layer was deposited, the specimens were placed in a vacuum oven at 70 to 120 degrees C. for 5 to 120 minutes. Then, the reactive polymer to be grafted (e.g. polyacrylic acid, polyethyleneimine, carboxy and aminoterminated polymers) was deposited on the fibrous substrates by dip coating from 0.2 to 5 weight/volume percent solution in a respective solvent. The materials were then placed in a vacuum oven at 50 to 160 degrees C. and annealed for 5 to 120 minutes. After the thermal treatment, the samples were washed 1 to 5 times with a solvent to remove any ungrafted material.

The choice of the reactive polymer is determined by the types of additional coupling chemistry that may be required. For example, if the detoxifying agent has a cationic functionality, then polyacrylic acid would be employed as it presents an anionic surface for binding. The opposite situation (i.e., a cationic surface) occurs in the case of polyethyleneimine.

### Example 2

Example 2 pertains to the aspect of the invention directed to application of nano-particles to fiber surfaces, and particularly to application of calcium carbonate nano-particles (CaCO₃) by means of spin finish dip coating. In order to achieve a high concentration of CaCO₃ nano-particles on the surface of the capillary-channeled polypropylene fibers, an application of a spin finish containing the nano-particles can be used. Advantageously, it is noted that while CaCO₃ is used in the present instance, any nano-particle may be selected on the basis of the desired end use application. For instance, titanium oxide (TiO₂) nano-particles may be selected for decontamination applications.

Returning to the present example, two different concentrations of CaCO₃ nano-particles were dispersed in ChemLube 22 spin finish. One preparation included 2.5 percent by weight CaCO₃, and the other included 10 percent by weight CaCO₃. Each of the 10 percent and 2.5 percent preparations was continuously stirred to maintain a dispersion of the CaCO₃ in the ChemLube 22. While each solution was being stirred, the fiber sample was quickly dipped into the solution and removed. It was suspended above a paper towel to dry and later placed on the paper towel to absorb any excess spin finish that was present.

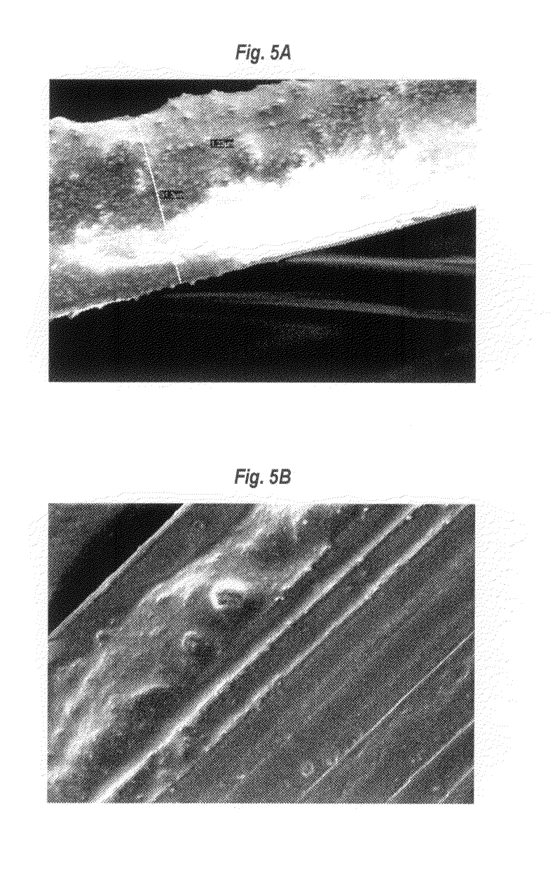

As shown in FIGS. 5A and 5B, images taken using a Field Emission Scanning Electron Microscope (FE SEM) suggest that both the 2.5 percent and the 10 percent concentrations were successful in coating the fibers. FIG. 5A depicts a side view of the fiber with the 10 percent CaCO₃ nano-particle dispersion on the fiber. The 10 percent concentration of calcium carbonate has covered the grooves in the shape of the capillary-channeled polymer fiber showing a peppered appearance. Using the 2.5 percent concentration nano-particle dispersion, as shown in FIG. 5B, the image shows that the relative level of loading can be controlled so that only partial filling of the grooves is obtained.

### Example 3

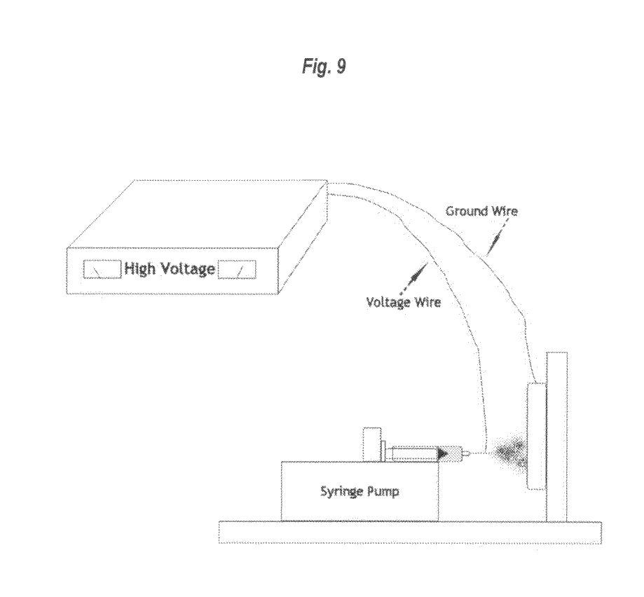

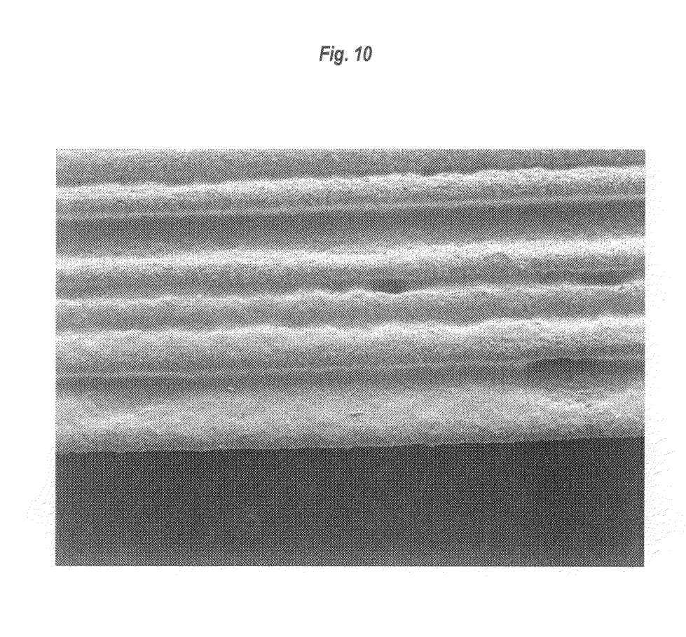

Example 3 pertains to the aspect of the invention directed to electrospraying particles containing polymer solutions to coat grooved fiber surfaces. The electrospray process is depicted schematically in FIG. 9. In the present example, a high voltage unit was used at 20 kV to electrospray a fine mist of 5 weight percent particles dispersed in a 1 percent solution of polyvinyl alcohol (PVA) to coat grooved fiber surfaces of capillary-channeled polymer fibers. The fiber, in this example, was placed in front of the ground plate. Loading of the particles on the fibers can be varied to obtain the desired loading level by changing the time of spraying and the particle loading in solution. With regard to this example, a 5 percent by weight loading was used. As shown in FIG. 10, the scanning electron microscopy image illustrates that it was possible to apply particles and nano-particles to the fiber and bind them in place via electrospraying.

### Example 4

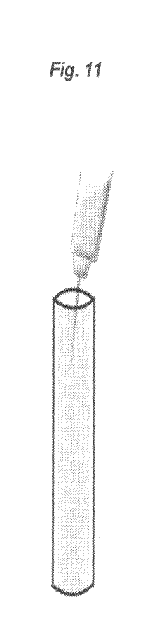

Example 4 pertains to the aspect of the invention directed to application of particles to coat grooved fiber surfaces by dip coating injection. For this example, the capillary-channeled polymer fibers were melt spun using a Hills Research Extruder using iPP spun at a melt temperature of 240 degrees C. into a 30 filament yarn. The method utilized in this example is designated as the dip coating “injection method,” depicted schematically in FIG. 11, whereby fibers are drawn through small plastic tubes and the solution is then injected into the top of the tubes. To apply the solution to the fibers, a bundle of each polypropylene fiber size is inserted into a small plastic tube and injected from the top end with the solution. As the solution settles within the tube, the solution surrounds each fiber. Following water evaporation, the particles are left behind in the channels of the fiber.

With specific regard to this example, solutions containing a percentage of polyvinyl alcohol (PVA) were first prepared by solubilizing the PVA in distilled water. Once solubilized, additional additives such as particles and nano-particles can be dispersed via continuous stirring. Recipes for the individual examples are provided in Table 1 below. Advantageously, however, this aspect of the invention is not restricted to any single polymer. Rather, any typical polymers usable to coat fibers may be selected, including, but not necessarily limited to, siloxanes, fluorocarbons and water soluble polymers, such as PVA.

TABLE 1
Composition and Percentages

| Polymer | | | | | |
|---|---|---|---|---|---|
| Solution | Particles | | Solvent | Coating | Crosslinking |
| (wt %) | (wt %) | Solvent | (ml) | polymer | Agent (ratio) |
| A (3.5%) | 16.0 | Water | 300 | PVA | — |
| B (4%) | 25.0 | Water | 200 | PVA | — |
| C (5%) | 10.0 | Isopentane | 100 | PDMS | 1:10 |

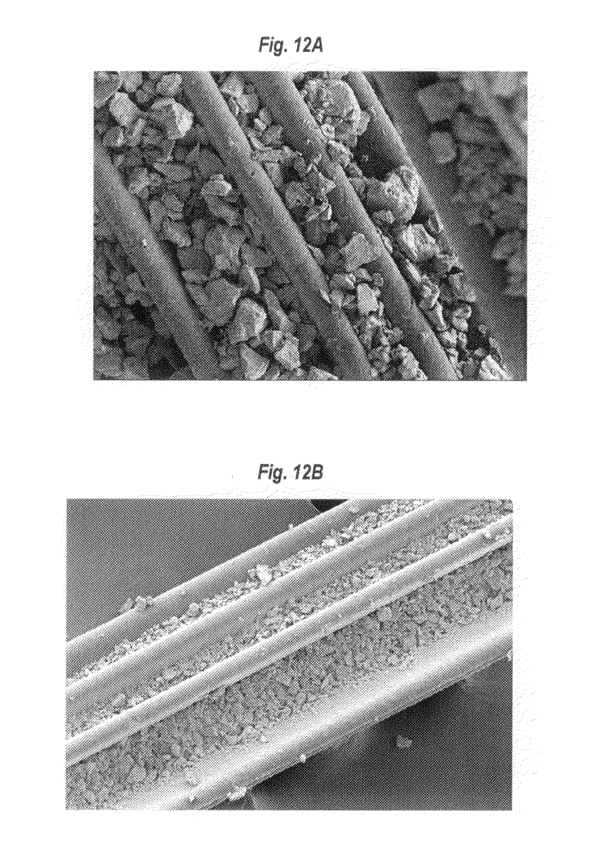

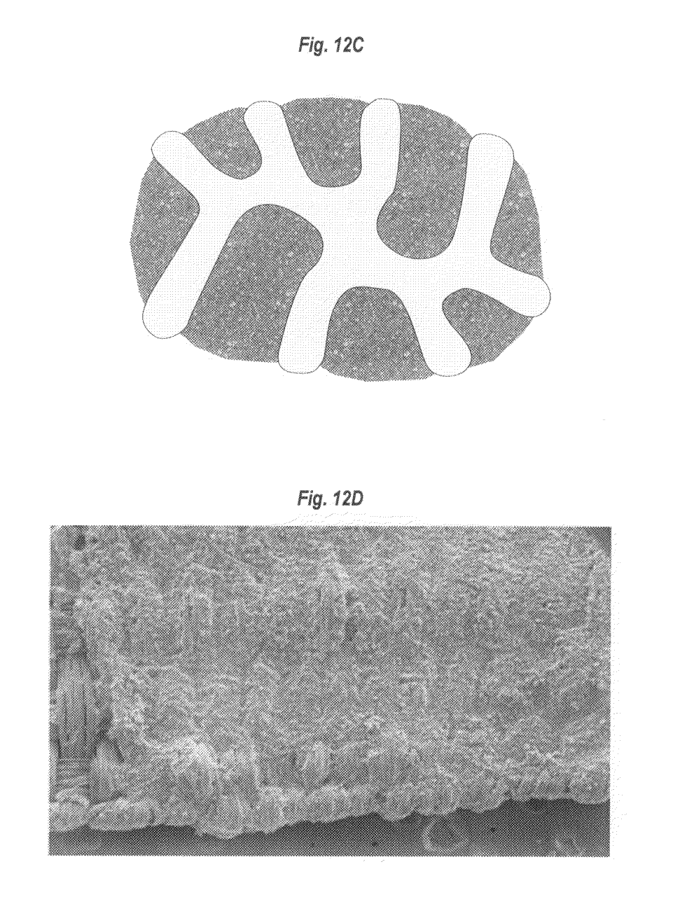

By using PVA as the particle media carrier after application, as with Solutions A and B, a possibility exists that the PVA can be removed from the fiber surface by washing to leave behind the “naked particles.” In connection with Solution A of Table 1, FIG. 12A is a scanning electron microscopy image of a capillary-channeled polymer fiber after treatment by dip coating injection with 16 percent particles by weight and 3.5 percent polyvinyl alcohol (PVA) solution by weight. In connection with Solution B of Table 1, FIG. 12B is a scanning electron microscopy image of a capillary-channeled polymer fiber after treatment by dip coating injection with 25 percent particles by weight and 4 percent polyvinyl alcohol (PVA) solution by weight. FIG. 12C is a cross sectional representation of a capillary-channeled polymer fiber after treatment by dip coating injection in accordance with this example.

Solution C of Table 1 was made from polydimethylsiloxane (PDMS) Dow Corning Sylgard 184. Unlike solutions using PVA, once PDMS is applied, it will be permanently bound to the fiber and cannot be removed under normal circumstances. In one aspect of this example, a small quantity of experimental fabric, approximately 5 cm by 10 cm in size, was woven from poly(ethylene terephthalate) (PET) capillary-channeled polymer fiber. A solution of PDMS was dissolved in isopentane and 10 percent by weight of particles dispersed in the solution. The fabric was immersed in the solution for 30 minutes, essentially by a dip coating method. Upon removal of fabric from the solution, the isopentane solvent, which has a boiling point, of 28 degrees C., evaporates at room temperature. The particles are thereby locked onto the fabric via the PDMS layer. In connection with this aspect, FIG. 12D is a scanning electron microscopy image depicting the woven fabric following treatment by this dip coating method. In industry, this process may be scaled up via a pad-dry-cure process. In accordance with this process, the particle slurry first has the fabric passed through it, the fabric is then squeezed through two rollers, and the fabric is then passed through a heated oven to crosslink or “cure” the PDMS elastomer onto the fabric. Completion of the process effectively locks the particles into the grooved fiber fabric.

It will be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiments, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

What is claimed is:

1. A method of preparing a fiber for use in defending against a biological or a chemical contaminant, the method comprising:
providing a fiber having a non-circular cross section and a fiber surface, and modifying the fiber surface of the fiber with an active agent to defend against a biological or a chemical contaminant.

2. The method according to claim 1, wherein the fiber is a capillary-channeled fiber with a surface having grooves or channels thereon.

3. The method according to claim 2, wherein the fiber surface of the non-circular cross section fiber is modified by deposition of a coating in the grooves or channels of the fiber.

4. The method according to claim 2; wherein the fiber surface of the non-circular cross section fiber is modified by deposition of particulate matter in the grooves or channels of the fiber.

5. The method according to claim 3, wherein the coating provides bacteriostatic or bacteriocidal activity against a biological contaminant or absorptive, adsorptive or neutralizing activity against a chemical contaminant.

6. The method according to claim 4, wherein the particulate matter provides bacteriostatic or bacteriocidal activity against a biological contaminant or absorptive, adsorptive or neutralizing activity against a chemical contaminant.

7. The method according to claim 2, wherein the grooves or channels of the fiber are of a size capable of entrapping or repelling airborne particulate matter.

8. A method of making a fiber for use in defending against a biological or a chemical contaminant, the method comprising:
selecting a fiber to have a non-circular cross section and a fiber shape to defend against an identified biological or chemical contaminant, and extruding the fiber.

9. The method according to claim 8, wherein the extruded fiber is a capillary-channeled fiber with a surface having grooves or channels thereon.

10. A fiber for use in defending against a biological or a chemical contaminant wherein the fiber comprises a non-circular cross section and a fiber shape that is selected to defend against an identified chemical or biological contaminant.

11. The fiber according to claim 10, wherein the fiber is a capillary-channeled fiber with a surface having grooves or channels thereon.

12. The fiber according to claim 10, wherein the fiber is modified by deposition of a coating within the grooves or channels of the fiber.

13. The fiber according to claim 10, wherein the fiber is modified by deposition of particulate matter within the grooves or channels of the fiber.

14. The fiber according to claim 12, where the coating wherein provides bacteriostatic or bacteriocidal activity against a biological contaminant or absorptive, adsorptive or neutralizing activity against a chemical contaminant.

15. The fiber according to claim 13; where the particulate matter provides bacteriostatic or bacteriocidal activity against a biological contaminant or absorptive, adsorptive or neutralizing activity against a chemical contaminant.

16. The fiber according to claim 11, wherein the grooves or channels of the fiber are of a size capable of entrapping or repelling airborne particulate matter.

17. A method of preparing an article for use in defending against a biological or a chemical contaminant, the method comprising:
providing a fiber having a non-circular cross section and a fiber surface having grooves or channels thereon, wherein the grooves or channels comprise an active agent having bacteriostatic or bacteriocidal activity against a biological contaminant or having absorptive, adsorptive or neutralizing activity against a chemical contaminant, and forming an article comprising the fiber.

18. The method according to claim 17, wherein the grooves or channels of the fiber are of a size capable of entrapping or repelling airborne particulate matter.

19. An article for use in defending against a biological or a chemical contaminant, the article comprising:
a fiber having a non-circular cross section and a fiber surface having grooves or channels thereon, wherein the grooves or channels comprise an active agent having bacteriostatic or bacteriocidal activity against a biological contaminant or having absorptive, adsorptive or neutralizing activity against a chemical contaminant.

20. The article according to claim 19, wherein the article is selected from the group consisting of a face mask, filter, tent netting, and fabric.

21. The method according to claim 17, wherein the active agent is a coating, particulate matter, or a combination thereof.

22. The method according to claim 19, wherein the active agent is a coating, particulate matter, or a combination thereof.
